(19) United States
(12) Patent Application Publication
(10) Pub. No.: US 2015/0258510 A1
(43) Pub. Date: Sep. 17, 2015

(54) Device For Injecting Then Mixing Polymer In A Pipe Carrying A Solid Particle Suspension, And Method Implementing The Device

(71) Applicant: S.P.C.M. SA, Andrezieux Boutheon (FR)

(72) Inventor: René Pich, Saint Etienne (FR)

(73) Assignee: S.P.C.M. SA, Andrezieux Boutheon (FR)

(21) Appl. No.: 14/432,303

(22) PCT Filed: Oct. 14, 2013
(86) PCT No.: PCT/FR2013/052443

§ 371 Date: Mar. 30, 2015

(30) Foreign Application Priority Data
Nov. 5, 2012 (FR) 1260497
Jun. 28, 2013 (FR) 1356292

(51) Int. Cl. B01F 7/00; B01F 15/02; B01F 15/00; C02F 1/54

(52) U.S. Cl. CPC B01F 7/00908; C02F 1/54; B01F 15/0254; B01F 15/0048; B01F 7/0025; B01F 7/00041; C02F 2103/10

(57) ABSTRACT

A device for injecting polymer into, then mixing in, a pipeline carrying a suspension of solid particles, includes, in combination at least one flange accepting polymer injection pipeline, and a stirrer including a rotor with at least one stirring blade positioned at right angles to the flow, with the rotor being rotationally driven by a drive.

### FIELD OF THE INVENTION

The invention relates to a device that makes it possible to inject inline, into a pipeline carrying a suspension of solid particles, water-soluble polymers and to mix these with said suspension, all in an optimized way. The device thus makes it possible to improve the flocculation of the suspensions of solid particles in the water. Another subject of the invention is a method implementing the device.

### BACKGROUND OF THE INVENTION

In-line flocculation in pipeline carrying suspensions of solid particles in water, particularly mine wash or sludge, has been known for over 50 years. However, despite the improvements made, optimum use of the flocculant can still not yet be achieved today.

What is meant by “suspensions of solid particles in water” is notably all types of sludge, such as, for example, urban sludge, sludge from the papermaking or agrifoodstuffs industry, drilling mud, industrial sludge and all mine wash and waste products from exploiting mines, such as, for example, coalmines, metal mining or sludge derived from the treatment of asphaltic sand. These suspensions generally comprise organic and/or mineral particles such as clays, sediments, sand, metal oxides, etc., mixed with water.

The very first in-line flocculation methods involved injecting dilute solutions directly into the pipeline carrying the suspensions of solid particles in water. The system was then improved with concentric multi-point injections with a static mixer or mixing involving recirculation of the water. Mention may be made of Nalco's Pareto™ mixing technology and Wetend Technology's Trumpjet™ product, both used especially in the papermaking industry.

The problem is that mixing and then flocculating require the suspension of solid particles in water and the flocculant to be in contact with one another for a certain length of time. Further and above all, this contact is achieved at high shear in the pumping line usually operating at a flow rate of 1 to 3 meters per second.

Attempts have been made at addressing this problem by changing and optimizing the injection point but, technically, it is impossible to obtain a satisfactory result because the mixing and flocculating steps occur concomitantly. The suspensions are not entirely flocculated and free and unused residual flocculant remains. That means that it is necessary to over-apply the flocculants in order to obtain complete flocculation of all the particles at once, and of all the flocs that have been broken up by the shearing (reflocculation).

By comparison with laboratory tests, flocculant consumption may be 30% to 100% higher, depending on the speed of the fluid.

Another method is to introduce an in-line mechanical mixer at a distance close to the outlet point so that degradation of the flocs already formed is minimized. Indeed it has been noted that if the sludge and the flocculant are mixed well, flocculation itself becomes rapid and uniform. To do this, use is made of pumps, stirred tanks, stirrers on an elbow in the pipeline. A significant improvement has been obtained using the technology described in U.S. Pat. No. 5,993,670.

This apparatus consists of a stirrer mounted in the pipeline, at right angles thereto, and able to rotate at high peripheral speeds optimized using a speed variator. The flocculant is injected via the stirring shaft which is perforated along its length.

It has allowed a considerable reduction in the amount of flocculant consumed, particularly with urban sludge before a centrifuge or a band filter or treatment of dredging sludge.
Injecting via the drive shaft has a limited effect because the mixing time is very short, which means that very high speeds have to be achieved in order to obtain the optimum result. These high speeds may cause the sludge to be ground down, thus increasing its specific surface area and making it even more difficult to treat.
Because the flocculant or coagulant flow rate varies, injection is not uniform over the length of the shaft and it is not possible to modify the diameter of the perforations in order to optimize this during operation.

The document US2004/013032A4 describes an in-line mixer that consists of a pipeline with a flange that accepts chemical injection pipeline. Downstream of this flange, there is a stirrer that rotates under the effect of the flow. No drive means for the rotor is described.

The document WO97/46310 describes a mixer that is inserted into a pipeline carrying papermaking fibres at a high concentration. The objective is to create high shear so as to degrade the fibres and bring them into contact with a chemical agent. The mixer is in the form of a rotor/stator, which enables high shear to be created. As mentioned earlier, flocculation does not require high shear, and so the rotor/stator system described in that document is not suitable.

The document EP 280 234 pertains to the same technical domain as the previous document. It describes a mixing system that creates high shear in a pipeline in which papermaking fibres are circulating. The pipeline also contains a port through which chemicals can be introduced. The stirrer is in the form of a double rotor that forms a valve. Like the previous one, this system is not suitable for flocculation either.

It is therefore necessary to develop, for the treatment of suspensions of solid particles in water, a new system for improving the effectiveness of the flocculant added in line.

### SUMMARY OF THE INVENTION

The applicant has developed a device that addresses this problem whereby the injection and assisted-mixing phases are well separated.

Thus one subject of the invention is a device for injecting polymer into, then mixing in, a pipeline carrying a suspension of solid particles.
at least one flange that accepts polymer injection pipeline,
a stirrer comprising a rotor with at least one stirring blade positioned at right angles to the flow, with the rotor being rotationally driven by a drive means.

In other words, the stirrer consists solely of a single rotor with at least one blade, which is positioned at right angles to the flow. This makes it possible to ensure homogeneous and uniform mixing, without any risk of breaking the flocs obtained by shearing.

According to a first embodiment, the device is in the form of a length of pipeline open at both ends so that it can be inserted into the pipeline carrying the suspension that is to be treated, said length of pipeline being equipped in succession, in the direction in which the suspension flows, with at least one flange that accepts the polymer injection pipeline, and the stirrer.

In practice, the length of pipeline has a diameter of between 50 and 1000 mm, advantageously between 100 and 500 mm.

In a second embodiment, the device of the invention consists of two separate elements, in the suspension's direction of flow, which are respectively the flange receiving the polymer injection pipeline and the stirrer. Each of them is to be inserted separately into the pipeline. This layout is particularly advantageous when the diameter of the pipeline is too large (greater than 12 inches, in practice around 20 to 40 inches). Indeed, in these conditions, the installation of a pipe section tends to reduce the stiffness of the pipeline, which creates problems.

In practice, in this embodiment, the stirrer is inserted into the pipeline through a flange whose diameter corresponds to around half of the main pipeline's diameter.

This embodiment is particularly advantageous in papermaking. The device is then preferably arranged after the centri-screen, which allows flocculation to be carried out without destroying the flocs that are formed thereby.

Regardless of the embodiment, the drive means of the rotor, which is also called “pipelinethe stirring shaft”, is advantageously:
either a motor mounted directly on the stirring shaft;
or a belt-pulley system and a motor, particularly in the case of high-powered motors.

Advantageously, the motor shaft is fitted with simple or double mechanical packing or with a gland, depending on the product that is to be treated or the line pressure.

In a particular embodiment, the packing is protected by a metallic or concentric plastic plate against the shaft and is at a distance of around one millimeter from the shaft. In these conditions, the space between the packing and the plate is supplied with water using a water supply channel that is installed for this purpose.

According to another feature, the motor has an adapted power. Further, the rotational speed of the stirrer is advantageously regulated by a speed variator in order to optimize flocculation.

According to another feature, the stirrer has two or four stirring blades. Their shape is advantageously oblong, circular or trapezoidal and their surface area is from 0.2 to 0.9 times, preferably from 0.3 to 0.7 times the internal cross section of the pipeline carrying the suspension that is to be treated.

According to another feature, the device of the invention advantageously comprises two or three flanges, each of which accepts polymer injection pipeline, so that flocculation can be optimized by injecting polymers different at distances away from the stirrer. These flanges are positioned as follows: the first flange is positioned, measuring from the stirrer shaft, at a distance equivalent to twice the internal diameter of the pipeline, the second flange at a distance equivalent to 4 times the internal diameter of the pipeline and the third flange at a distance equivalent to 6 times the internal diameter of the pipeline. In most cases, effectiveness does not increase further beyond this distance.

Each flange is preferably made up of two concentric tubes, advantageously a perforated outer tube and an inner tube that is able to move and longitudinally slotted and capable progressively of closing off the holes in the first tube. That means that the polymer can be metered and makes it possible to create the pressure drop necessary for good distribution of flocculant along the length of the injection pipeline.

This system allows substantial adjustments dependent notably on the product that is to be treated, on the concentration and viscosity of the suspension and on the speed of the fluid. In particular it allows the injection point and the quantity of polymer injected to be varied, thus providing the operator with a great deal of flexibility, both when testing and also during industrial operations when the composition and concentration of the sludge vary.

A person skilled in the art will know how to adapt the device in order to take full advantage of the optimization of suspension treatment performance.

Another subject of the invention is a pipeline carrying a suspension of solid particles, which is equipped with the device described hereinabove.

The position of the device on the pipe will advantageously be far closer to the outlet than with a normal injection. Typically, the device is inserted on the pipeline at a distance equivalent to 5 to 50 times the diameter of said pipeline measured from the outlet point thereof.

Another subject of the invention is a method implementing the above-described device and, in particular, an in-line treatment method consisting in using this device to inject a water-soluble polymer into, and then mix it in, a pipeline carrying a suspension of solid particles in water.

More specifically, a subject of the invention is a method of flocculating a suspension of solid particles which is carried by a pipeline implementing the device described hereinabove and consisting in:
inserting the device into the pipeline carrying the suspension
injecting at least one water-soluble polymer into the injection pipeline
discharging the suspension thus flocculated.

The suspension thus treated is, for example, discharged onto a sludge dewatering device or system (band filter, press filter, centrifuge), or into a pool or flat area in which the water separates very rapidly from the sludge by flocculation allowing the sludge to settle and/or to dry out.

The method performs particularly well in the treatment of mine wash and in installations for treating water containing mineral substances in suspension (quarries, truck washes, mines, the hydrometallurgic industry) and for the treatment of urban sludge and dredging sludge.

According to one feature of the method, one or more water-soluble polymer(s) can be injected at one or more injection points, using the injection pipeline and flanges of the device.

The water-soluble polymers are flocculants. They are preferably used in the form of a solution in which the polymer or polymers is or are dissolved.

All chemical kinds of flocculant can be used: natural flocculants or polysaccharides or synthetic flocculants.

The water-soluble polymers are preferably based on acrylamide. Of these polymers, copolymers prepared from the following monomers are particularly advantageous: acrylic acid, ATBS (2-acrylamido-2-methylpropane sulfonic acid), diallyldimethylammonium chloride (DADMAC), dialkylaminoethyl acrylate (ADAME) and dialkylaminoethyl methacrylate (MADAME) and the acidified or quaternized salts thereof, N-vinyl pyrrolidone. Ethylene polyoxides, amine polyethylene may also be used in these polymers.

The following example illustrates the invention but is entirely nonlimiting.

### BRIEF DESCRIPTION OF THE DRAWINGS

FIG. 1 is a schematic view of the device of the invention according to a first embodiment.

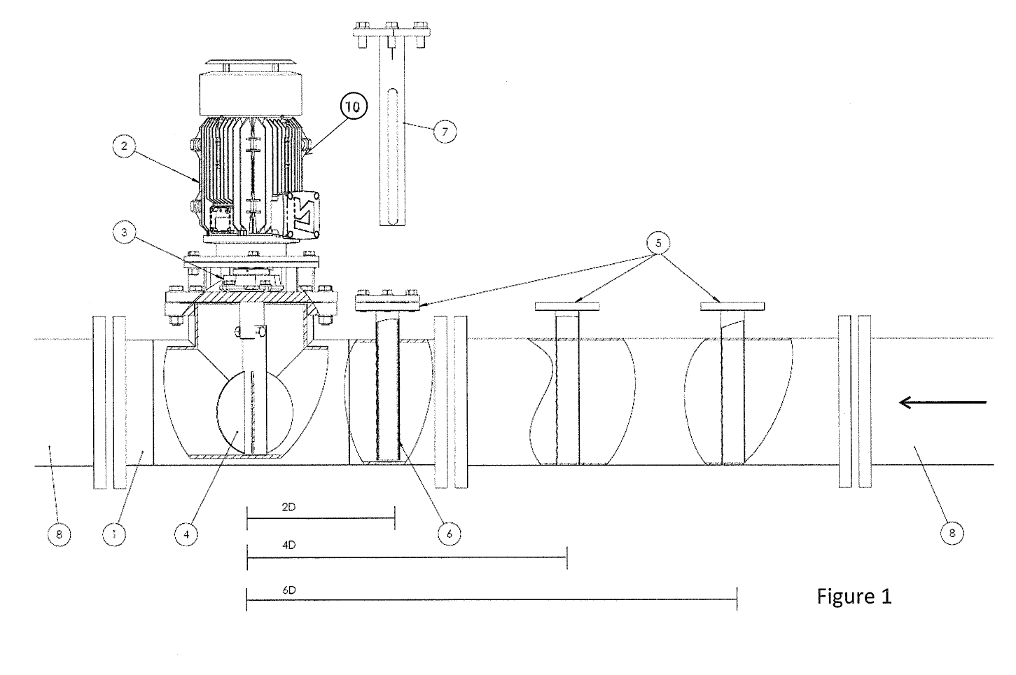

FIG. 2 is a schematic view of the device of the invention according to a second embodiment.

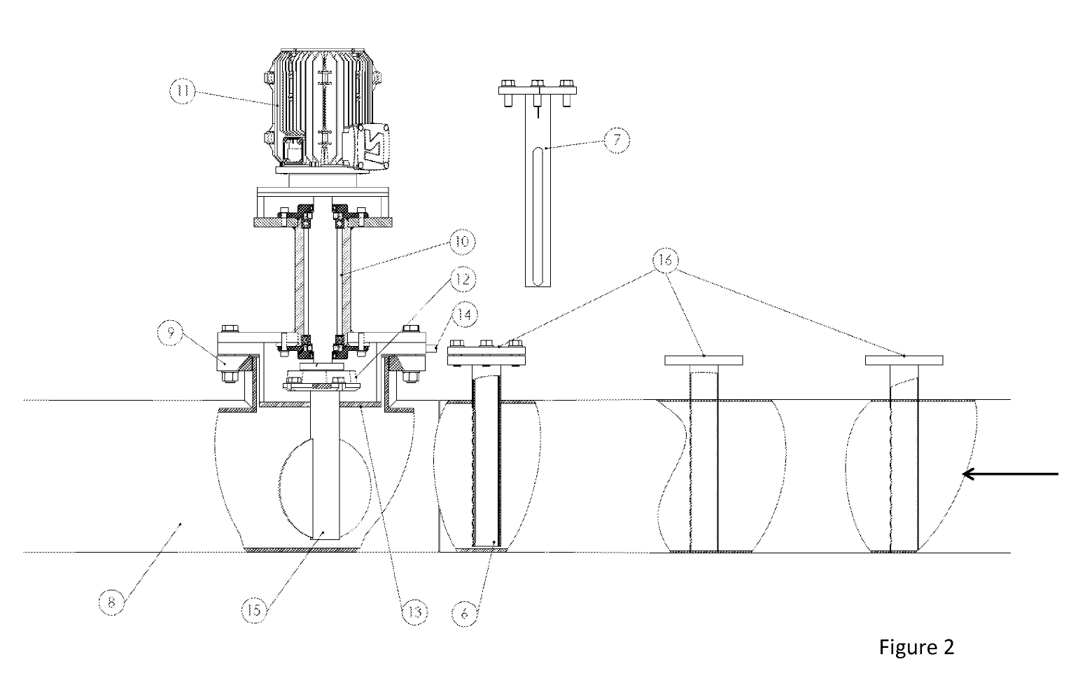

### DETAILED DESCRIPTION OF THE INVENTION

### Example 1

The device of the invention, comprising the following elements:
a pipeline section (1) of the same diameter as the main pipeline: 150 mm (6 inches),
a stirrer (10) comprising:
   a motor (2) with a power of 4 kW, rotating at 1500 revs, and able to rotate via a variator at from 300 to 2200 revs/min,
   a simple mechanical packing (3) made of silicon carbide,
   a quadruple semicircular stirring blade of a diameter of 120 mm (4),
three flanges (5) positioned at distances equivalent to twice, 4 times and 6 times the inside diameter of the pipeline, measured from the stirrer shaft,
injection pipeline (6) with an inside diameter of 20 mm, with a tube (7) of diameter 19 mm, slotted over its entire length, that makes the flow rate of polymer solution uniform over the entire length
   is inserted 10 meters away from the outlet of a pipeline carrying sludge originating from a dredging of argillaceous mud derived from the treatment of asphaltic sand.

The device is positioned in such a way that, in the direction in which the suspension flows, the stirrer is downstream of the flanges.

The polymer injected is an acrylamide and acrylic acid copolymer with a molecular weight of 15 million Daltons, and is in the form of a solution.

This installation, tested comparatively against single-point injection into the pipeline, reduced water-soluble polymer consumption by 23% at a modest stirring speed of 1700 rev/min.

### Example 2

In a papermaking plant, the device of the invention is inserted into the pipeline (8) supplying the headbox, after the centri-screen said device including the following components:
A flange (9) with a diameter that is half (15 inches) of the main pipeline's diameter (20 inches), in which the stirrer is inserted (10),
the stirrer motor (11) with a power of 4 kW, rotating at 1500 revs, and able to rotate via a variator at from 300 to 2200 revs/min,
a simple mechanical packing (12) made of silicon carbide,
a metallic plate (13) for protecting the mechanical packing; the plate is concentric with the shaft and is at a distance of around one millimeter from the shaft,
a water supply channel (14) used to inject clean water between the packing (12) and the plate (13), so as to protect the packing,
a double, semicircular stirring blade of 8 inches (15) diameter,
three flanges (16), each of which accepts the polymer injection pipeline, positioned at distances equivalent to twice, 4 times, and 6 times the inner diameter of the main pipeline (8), measured from the stirrer shaft,
polymer injection pipeline (6) with an inner diameter of 20 mm, with a slotted tube (7).

The polymer injected is copolymer made of acrylamide and acrylic acid with a molecular weight of 15 million Daltons, in solution.

Compared to a pipeline single injection, the installation has reduced hydrosoluble polymer consumption by 31% at a reasonable stirring speed of 1500 tours/min.

1. A device for injecting polymer into, then mixing in, a pipeline carrying a suspension of solid particles, comprising, in combination:
at least one flange receiving polymer injection pipeline,
a stirrer consisting of a rotor with at least one stirring blade (4) positioned at right angles to the flow, said rotor being rotationally driven by a driver.

2. The device according to claim 1, wherein said device has a pipeline section open at both ends so that it can be inserted into the pipeline carrying the suspension that is to be treated, said pipeline section being equipped in succession, in a direction in which the suspension flows, with at least one flange accepting polymer injection pipeline, and the stirrer.

3. The device according to claim 1, wherein said device consists of two separate elements, in the suspension's direction of flow, which are respectively the flange receiving the polymer injection pipeline and the stirrer, each of them being insertable separately into the pipeline.

4. The device according to claim 1, wherein the shaft driver of the rotor is a motor mounted directly on the rotor, the speed of which is regulated by a speed variator.

5. The device according to claim 1, wherein the stirrer is equipped with two or four stirring blades, of oblong, circular or trapezoidal shape, and with a surface area of between 0.2 and 0.9 times the internal cross section of the pipeline carrying the suspension that is to be treated.

6. The device according to claim 1, wherein the stirrer includes a mechanical packing that is protected by a metallic or plastic plate.

7. The device according to claim 6, wherein the stirrer includes a water supply input supplying the space between the packing and the plate.

8. The device according to claim 1, and which includes 2 or 3 flanges, each of which receive a polymer injection pipe.

9. The device according to claim 8, wherein the flanges are positioned as follows: the first flange is positioned, measuring from the stirrer shaft, at a distance equivalent to twice the internal diameter of the pipeline, the second flange at a distance equivalent to 4 times the internal diameter of the pipeline and, if there is a third flange, this is positioned at a distance equivalent to 6 times the internal diameter of the pipeline.

10. A pipeline carrying a suspension of solid particles, equipped with the device according to claim 1.

11. A method of flocculating a suspension of solid particles which is carried by a pipeline implementing the device according to claim 1 and consisting in:
inserting the device into the pipeline carrying the suspension,
injecting at least one water-soluble polymer into the injection pipeline,
discharging the flocculated suspension.

12. The method according to claim 11, wherein the pipeline carries mine wash, water containing mineral substances in suspension (quarries, truck washes, mines, the hydrometallurgic industry), urban sludge or dredging sludge.

13. The method according to claim 11, wherein the water-soluble polymers are flocculants and are in the form of a solution in which the polymer or polymers is or are dissolved.

14. The method according to claim 11, wherein the water-soluble polymers are based on acrylamide and chosen from copolymers prepared from the following monomers: acrylic acid, ATBS (2-acrylamido-2-methylpropane sulfonic acid), diallyldimethylammonium chloride (DADMAC), dialkylaminoethyl acrylate (ADAME) and dialkylaminoethyl methacrylate (MADAME) and the acidified or quaternized salts thereof, N-vinyl pyrrolidone.

15. The device of claim 5, wherein the surface area of the stirring blades is between 0.3 and 0.1 times the internal cross section of the pipeline carrying the suspension that is to be treated.
